(19) United States
(12) Patent Application Publication
(10) Pub. No.: US 2011/0064023 A1
(43) Pub. Date: Mar. 17, 2011

(54) WIRELESS COMMUNICATION SYSTEM

(76) Inventors: Akio YAMAMOTO, Hiratsuka (JP); Ryo KADOI, Fujisawa (JP); Masazumi TONE, Yokohama (JP)

(21) Appl. No.: 12/768,781

(22) Filed: Apr. 28, 2010

(30) Foreign Application Priority Data
Sep. 16, 2009 (JP) 2009-214008

(51) Int. Cl. H04W 40/00

(52) U.S. Cl. 370/328

(57) ABSTRACT

A wireless communication system comprises a host and a device. The host is provided with a communication unit capable of data communication using a first communication system and a second communication system which is higher in maximum transmission rate than the first communication system, and without regard to any communication system to be used by the device, the host uses the first communication system to start processing for establishment of a communication link with the device.

### INCORPORATION BY REFERENCE

This application claims the benefit of priority of Japanese Application No. 2009-214008 filed on Sep. 16, 2009, the disclosure of which also is entirely incorporated herein by reference.

### TECHNICAL FIELD

The present invention relates to a wireless communication system to transmit large-volume data such as USB 2.0 data and USB 3.0 data.

### BACKGROUND

USB (universal serial bus) interface scheme is increasingly used for data transmission between apparatuses, for example, between a PC (personal computer) and devices such as a printer and a digital camera.

JP-A-2009-032029 discloses that a WUSB (wireless USB) transmission/reception system. This system comprises a host-side WUSB transmitter/receiver having means to give a connection admission to a device to be connected without condition at all times and means to deem an authentication value as confirmed, and a device-side WUSB transmitter/receiver having means to deem an authentication value as confirmed.

### SUMMARY

In tune with an increase in data transmission capacity, the USB standard version has also been upgrading: in 2000, USB 2.0 of transmission rate up to 480 Mbps was standardized; in 2008, USB 3.0 with a transmission rate up to 4.8 Gbps was standardized. Where such version upgrades result in coexistence of a plurality of schemes, it is required, in order to improve the usability of users, to provide devices capable of supporting not only the existing schemes but also such newly provided scheme.

However, in order to make it possible to add a new scheme other than the existing schemes and to support a plurality of schemes, an increase of the number of components necessary for the new scheme such as terminals may impede miniaturization and cause production cost and power consumption to increase. For example where making it possible to add USB 3.0 other than USB 2.0 and support both of them, there is a problem that power consumption by wireless data transmission increases because USB 3.0 is broadband.

JP-A-2009-032029 does not disclose any method to adapt to such plurality of WUSB schemes.

It is therefore an object of this invention to provide a wireless transmission system adaptable to such plurality of WUSB schemes while preventing power consumption from increasing.

A wireless communication system in accordance with this invention comprises a host and a device. The host is provided with a communication unit capable of data communication using a first communication system and a second communication system which is higher in maximum transmission rate than the first communication system, and without regard to any communication system to be used by the device, starts processing for establishment of a communication link with the device by using the first communication system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration example of the wireless communication system.

FIG. 2 is a diagram showing a frequency band of UWB system.

FIG. 3 is a block diagram showing a configuration example of the wireless communication system.

FIG. 4 is a block diagram showing a configuration example of the wireless communication system.

FIG. 5 is a diagram showing a relationship between a UWB modulation scheme and band groups required therefor.

FIG. 6 is an illustrative diagram showing one example of an initial operation in the wireless communication system.

FIG. 7 is a diagram showing an operation sequence example between a host and a device or DWA.

FIG. 8 is a block diagram showing a configuration example of the wireless communication system.

FIG. 9 is a diagram showing an operation sequence example between a host and a device or DWA.

FIG. 10 is a block diagram showing a configuration example of the wireless communication system.

FIG. 11 is a block diagram showing a configuration example of the wireless communication system.

FIG. 12 is a diagram showing one example of a detailed configuration of a PHY/MAC.

### DETAILED DESCRIPTION

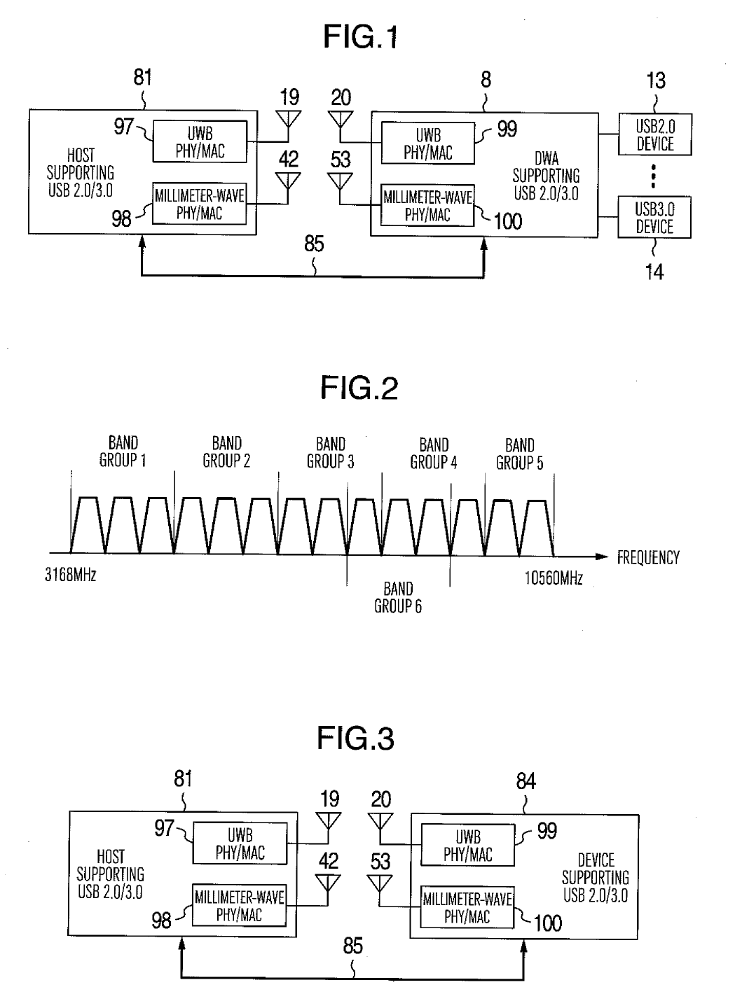

FIG. 1 is a block diagram showing a configuration example of the wireless communication system. Devices 13 and 14 are devices such as a digital camera and a printer, each of which supports USB 2.0 and USB 3.0. A host 81 is an apparatus such as a PC, which supports USB 2.0 and USB 3.0. In the system, by connecting a DWA (device wired adapter) 8 with communication hub function to the devices 13 and 14 via wired cable, wireless communications using USB 2.0 and USB 3.0 are performed with the host 81.

The host 81 performs association processing (initial authorization) with the devices 13 and 14 connected to the DWA 8, and shares with them a master key called the connection key unique to each device. Once the connection key is shared, the association processing will no longer be required for the future communication, and thus, it is possible to ensure the security of communication between the host 81 and the devices 13 and 14. Note that the association on the host side and device side is not limited to the cable association using a wired cable 85, and may also be performed by numerical association by means of numerical value input.

For example, the host 81 transmits/receives via an antenna 19 USB 2.0 data with transmission rate up to 480 Mbps by UWB (ultra wide band) (MB-OFDM: multi-band orthogonal frequency division multiplexing) scheme. The host 81 also transmits/receives via an antenna 42 USB 3.0 data up to 4.8 Gbps by High speed transmission system using millimeter-wave (millimeter-wave system) such as the IEEE 802.15.3c.

The host 81 has PHY/MACs 97 and 98. PHY is provided with a modem circuit, a radiofrequency circuit and others; MAC is provided with a wireless resource control circuit and others. The PHY/MAC 97 modulates USB 2.0 data into a UWB signal, or demodulates a UWB signal into USB 2.0 data. The PHY/MAC 98 modulates USB 3.0 data into a millimeter-wave signal, or demodulates a millimeter-wave signal to USB 3.0 data.

FIG. 2 is a diagram showing a frequency band used in UWB system. In the UWB system, a frequency range from 3,168 MHz to 10,560 MHz is divided into fourteen bands, two or three bands of which are combined together into a single band group, and thus the frequency range is divided into six band groups. In the existing UWB standard, a single band group is used to enable to transmit data up to 960 Mbps, wherein the PHY/MAC 97 corresponds to the single band group.

In FIG. 1, the devices 13 and 14 are connected to the DWA 8 to transmit/receive USB 2.0 data and USB 3.0 data via antennas 20 and 53. The antenna 20 transmits/receives USB 2.0 data up to 480 Mbps by the UWB system, whereas the antenna 53 transmits/receives USB 3.0 data up to 4.8 Gbps by the millimeter-wave system.

The DWA 8 is provided with PHY/MACs 99 and 100. The PHY/MAC 99 modulates USB 2.0 data into a UWB signal, or demodulates a UWB signal into USB 2.0 data. The PHY/MAC 100 modulates USB 3.0 data into a millimeter-wave signal, or demodulates a millimeter-wave signal into USB 3.0 data.

In this example, each of the host 81 and the DWA 8 has a transmitter/receiver for wireless transmission of USB 2.0 data and USB 3.0 data, which makes it possible to achieve wireless transmission of USB 2.0 data and USB 3.0 data.

As shown in FIG. 1, even where the USB devices 13 and 14 do not have the wireless transmission function, the wireless transmission of USB data can be performed by the DWA 8. Additionally, by adding a PHY/MAC supporting the new upgrade version USB 3.0, it is possible to perform the wireless transmission of data of a plurality of USB schemes, USB 2.0 and USB 3.0.

Where the devices have the wireless transmission function, the DWA 8 can be omitted. In the example shown in FIG. 3, the device 84 has the wireless transmission function, and thus uses no DWA. The device 84 such as a digital camera and a printer has itself the WUSB communication function and thus can support USB 2.0 and USB 3.0.

According to the example in FIG. 3, the device has itself the wireless function, and thus uses no DWA. Therefore, it is possible to use each device at any location. Note that in FIG. 3, the same elements as those shown in FIG. 1 are denoted by the same reference numerals, and explanations thereof are omitted herein.

Although in the examples in FIGS. 1 and 2, two antennas and two PHY/MACs are arranged on each of the host side and device side, and the transmission of USB 3.0 data uses a millimeter-wave, this invention is not limited thereto. For example, USB 3.0 data may also be transmitted by the UWB system using a multi-antenna and two or more band groups. In this case, the optimum modulation scheme depends on the number of such band groups, and thus it is necessary for the PHY/MAC to support a plurality of modulation schemes. However, providing one PHY/MAC for each modulation scheme would result in increasing the number of components required therefor, which might impede miniaturization and cause unwanted increase in manufacturing cost and power consumption.

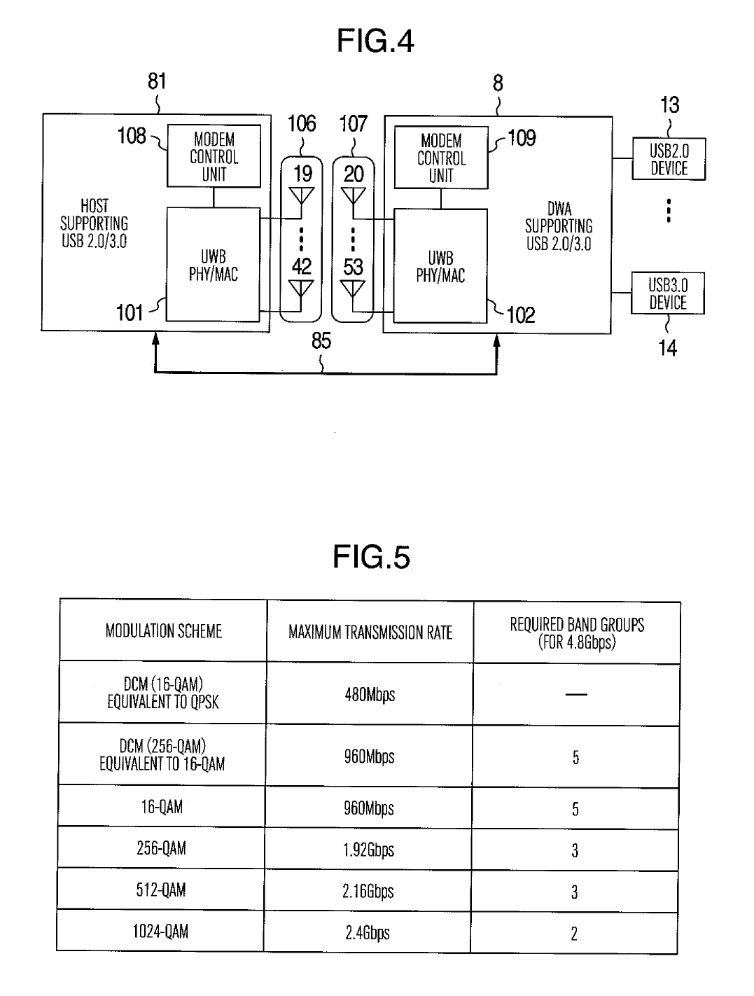

Consequently, where further miniaturization is required, it is preferable to provide a modem control unit 108 to support a plurality of modulation schemes using a single PHY/MAC as shown in FIG. 4. In FIG. 4, the same elements as those shown in FIG. 1 are denoted by the same reference numerals, and explanations thereof are omitted herein.

A multi-antenna unit 106 which has a plurality of antennas 19 to 42 can transmit/receive data of two or more band groups (e.g., up to 5 band groups shown in FIG. 2) by using any one or a plurality of antennas among them. A multi-antenna 107 which has a plurality of antennas 20 to 53 can transmit/receive data of two or more band groups in a similar way to the multi-antenna 106.

The host 81 and DWA 8 have the PHY/MACs 101 and 102 along with modem control units 108 and 109, respectively. Although each of the PHY/MACs 101 and 102 adapts to a single modulation scheme, its modulation scheme is changeable and adaptable to a plurality of band groups under control of the modem control units 108 and 109.

Here, FIG. 5 shows the relationship of modulation schemes and transmission rate along with the number of band groups required for transmitting 4.8 Gbps data. Note that the modulation schemes indicated in FIG. 5 include those standardized by the existing UWB systems: a DCM (dual-carrier modulation) equivalent to QPSK (quadrature phase shift keying), and DCM equivalent to 16-QAM (16-bit quadrature amplitude modulation). The remaining modulation schemes will possibly be standardized in near future.

In the example shown in FIG. 5, where USB 2.0 data is transmitted/received by the modem of UWB system, the data is transmitted/received using a single band group of DCM equivalent to QPSK or 16-QAM. Where USB 3.0 data is transmitted/received by the modem of UWB system, the data is transmitted/received using five band groups of either DCM equivalent to 16-QAM or 16-QAM; the data is transmitted/received using three band groups of either 256-QAM or 512-QAM; or the data is transmitted/received using two band groups of 1024-QAM. By doing so, transmission/reception of 4.8 Gbps data becomes achievable. In this case, the host 81 and DWA 8 control in such a way as to select the number of antennas within the multi-antennas 106 and 107 in accordance with the number of band groups used for such transmission/reception.

Other modulation schemes may also be used, such as phase modulation, amplitude modulation and code modulation. Note that FIG. 5 shows one example, and that the host may set it up, when establishing a communication link, in accordance with the information indicative of USB version received from the device as well as data rate and modulation scheme of transmission/reception.

As explained above, according to the example in FIG. 4, by providing the multi-antennas and the modem control units, only one PHY/MAC can transmit/receive data using a plurality of band groups.

Note that although in the example in FIG. 4 the DWA 8 is connected to the devices in a similar way to that in FIG. 1 and provided with one PHY/MAC and one modem control unit, this invention is not limited thereto. By providing one PHY/MAC and one modem control unit, the device shown in FIG. 3 which has the wireless function may also transmit/receive using a plurality of band groups.

In addition, the device is not limited to that supporting both USB 2.0 and USB 3.0, and this invention may be applied to that supporting only USB 3.0. As USB 3.0 is broadband, data can be transmitted/received successfully in a broadband by providing antennas corresponding to each band group.

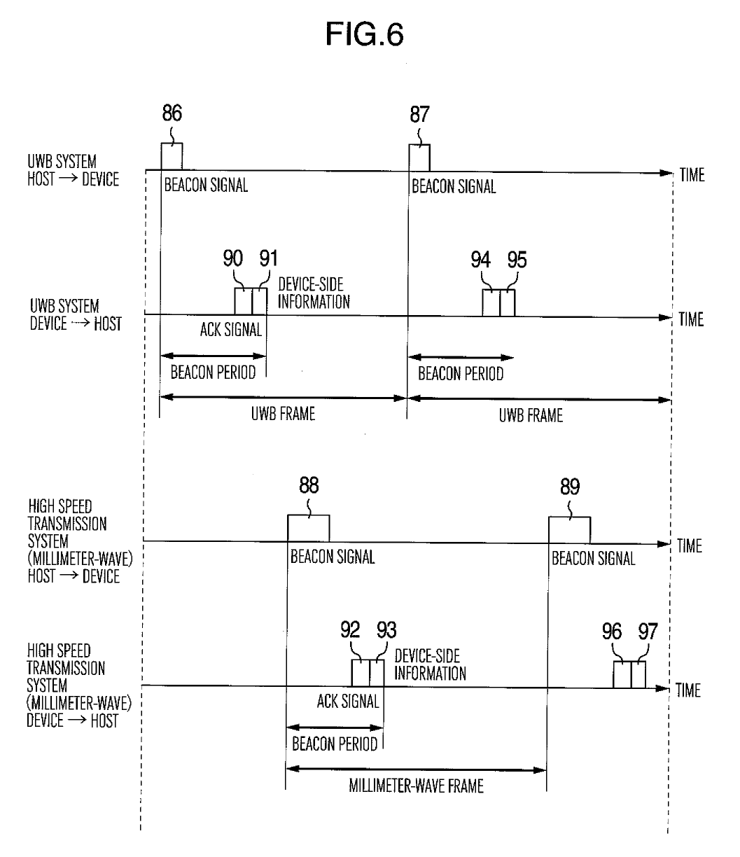

FIG. 6 shows one example of a connection operation at the beginning of a communication between the host and the device in the examples shown in FIGS. 1 to 4. The host supports both the UWB modulation scheme (using a single band group) and the millimeter-wave modulation scheme, and outputs beacon signals 86 and 87 and beacon signals 88 and 89 at constant time intervals, each of which corresponds to an inter-frame spacing. The beacon signals contain host-side information.

Upon receiving these beacon signals on the device side, an ACK (acknowledgment) signals 90, 92, 94 and 96 for notifying the reception and device-side information 91, 93, 95, and 97 are transmitted from the device to the host. The device-side information is, for example information indicating whether the device communicates via the DWA or has the wireless transmission function to communicate directly; information indicating whether the DWA and device support USB 2.0 or not and whether the DWA and device support USB 3.0 or not; and information indicating what modulation scheme is to be used.

Note that the host 81 controls so as to prevent transmission/reception of the beacon signals, the ACK signals and the device-side information from overlapping. For example, the beacon signal 88, the ACK signal 92 and the device-side information 93 are transmitted after transmitting the beacon signal 86, the ACK signal 90 and the device-side information 91.

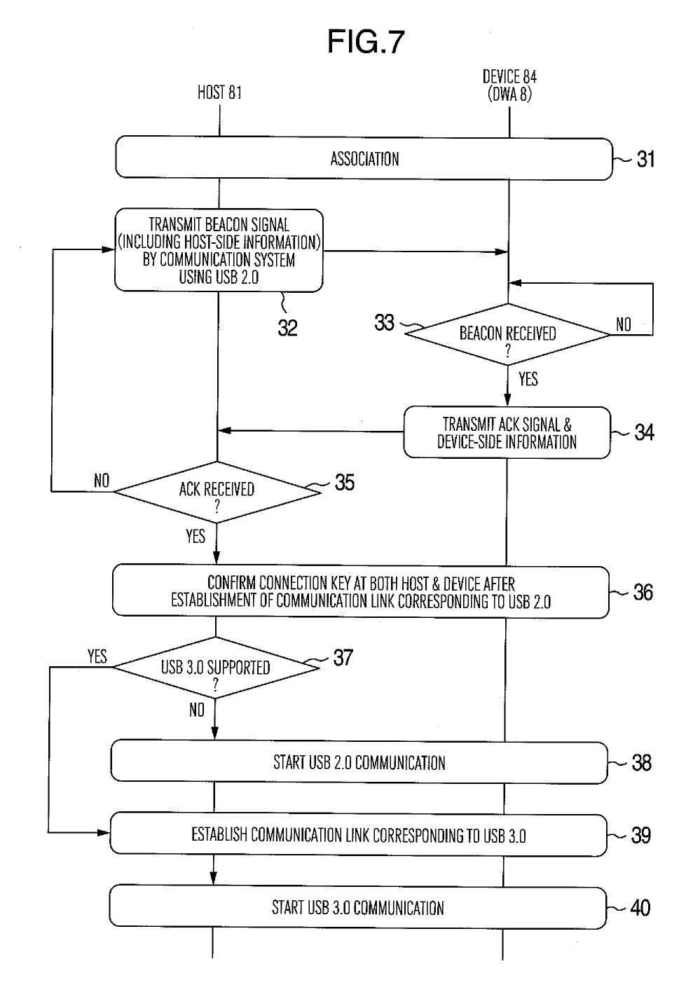

FIG. 7 shows the operation sequence example between the host 81 and the device 84 or DWA 8. Although the device 84 will be explained below as an example, the same goes for the DWA 8.

First, the host 81 and the device 84 perform association (step 31). By this association, the host 81 and device 84 share a host ID (identification), a device ID, a connection key, etc. Note that the association is executed only where a connection is established for the first time: for the second time and later, the processing gets started from step 32.

At step 32, the host 81 uses UWB system corresponding to USB 2.0 to transmit a beacon signal. When the device 84 receives the beacon signal (step 33), the device 84 transmits an ACK signal and device-side information to the host 81 (step 34).

When the host 81 receives the ACK signal (step 35), the host performs, after establishment of a communication link, authorization of the connection key between the host 81 and device 84 are performed based on the procedure such as so-called 4-way handshake (step 36).

Where the device 84 supports USB 2.0 and USB 3.0, a communication link is established by UWB system corresponding to USB 2.0. Typically, the system corresponding to USB 2.0 is less in power consumption than that corresponding to USB 3.0. For this reason, as shown in the example in FIG. 7, even where the device supports not only USB 2.0 but also USB 3.0, first a beacon signal is transmitted by the communication system using USB 2.0 and then a communication link is established by USB 2.0 scheme, which makes it possible to reduce power consumption. Here, the communication system using USB 3.0 is a high speed data transmission system such as millimeter-wave system, UWB system using a plurality of band groups and UWB system using multi-value modulation.

After finishing establishment of the communication link and confirmation of the connection key, the host 81 uses the device-side information received from the device 84 to determine whether the device 84 supports USB 3.0 or not (step 37). If the device 84 does not support USB 3.0 (i.e., “No” at step 37), it uses the communication link that was established at step 34 to start data communication (step 38). (Hereinafter, communication using USB *.* will also be referred to as USB *.* communication.)

On the other hand, if the device 84 supports USB 3.0 (i.e., “Yes” at step 37), the host establishes a communication link corresponding to USB 3.0 (step 39). After establishment of the communication link, a USB 3.0 communication starts (step 40).

By establishing a communication link by USB 2.0 scheme that is lower in transmission rate and performing the authorization as shown in this example, it is possible to suppress the increase in power consumption even where performing USB 3.0 communication. It is also possible to maintain the compatibility with existing models by initial establishment of a communication link corresponding to USB 2.0 scheme or establishment of a reliable communication with the device supporting only USB 2.0.

Although the device 84 or the like supports USB 2.0 and USB 3.0 in the example in FIG. 7, this invention is not limited thereto. Not only in the case where the device supports the USB 2.0 and USB 3.0 but also in the case where the device supports a plurality of schemes, it is possible to lower power consumption by performing the communication of a desired scheme after establishment of a communication link by a scheme selected from among them, which is the lowest in transmission rate. Alternatively, by establishing the communication link by a scheme, which is of the oldest version among the plurality of schemes, it is possible to establish a communication without fault even where an apparatus at the other end of a link does not support the new version.

Note that although in the examples in FIGS. 6 and 7 the host side transmits a beacon signal whereas the device side receives it and returns ACK signal, this invention is not limited thereto. By the device side transmitting the beacon signal and the host side returning the ACK signal, the communication link may also be established. Where the beacon signal is transmitted from the host side, it is possible to reduce power consumption on the device side; however, it is necessary for the host to transmit the beacon signal at all times in order to check whether a new device is present or not. Accordingly, where lower power consumption is more requested on the host side than on the device side, it is desirable to transmit the beacon signal from the device side, rather than from the host side. For example, the beacon signal-transmitting side may also be switched depending on whether an AC power supply is connected to the host or the device.

Where the ACK signal is not received at step 35 even after the elapse of a predetermined time period since the beacon signal was transmitted at step 32, the host 81 transmits a beacon signal by the communication system using USB 3.0. Then, upon receiving the ACK signal and device-side information, the host 81 performs authorization between the host and device after establishment of a communication link at step 39, and starts a USB 3.0 communication (step 40).

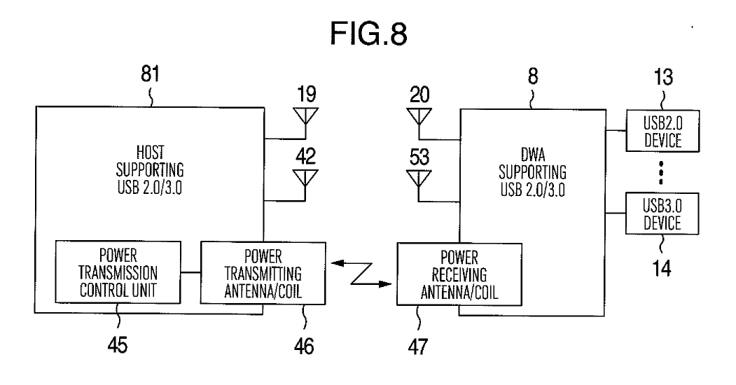

Further, as the example shown in FIG. 8, the host 81 in FIG. 1 may have a power transmission control unit 45 and a power transmitting antenna or transmitting coil 46 to transmit power wirelessly to the DWA 8 having a power receiving antenna or receiving coil 47. According to this example, power is wirelessly supplied to the DWA 8 and devices 13 and 14, and thus users can use the DWA 8 and devices 13 and 14 without connecting them to AC power supply. With such arrangement, it is possible to increase the degree of freedom of their installation locations.

In the example in FIG. 8, the power transmission control unit 45 detects based on the information received from the DWA 8, the number of devices connected to the DWA 8 and the USB versions of such devices, and controls transmitted power pursuant to these conditions. As the necessary power depends on the USB version of connected devices and the number of them, varying the amount of transmitted power makes it possible to reduce power consumption. For example, where the device supports USB 2.0, the supplied power is decreased; where the device supports USB 3.0, the supplied power is increased. Additionally, the supplied power is increased or decreased in response to increasing and decreasing in the number of devices.

Note that although not shown in FIG. 8, a battery is connected to the power receiving antenna or receiving coil 47. Also FIG. 8 shows one example of the power transmission of the communication systems shown in FIG. 1, and this invention is not limited to the example in FIG. 1. For example, other communication systems shown in FIGS. 3 and 4 may also have the power transmitting antenna or transmitting coil and the power receiving antenna or receiving coil to transmit power wirelessly. Where applying it to FIG. 3, the device 84 has the power receiving antenna or receiving coil.

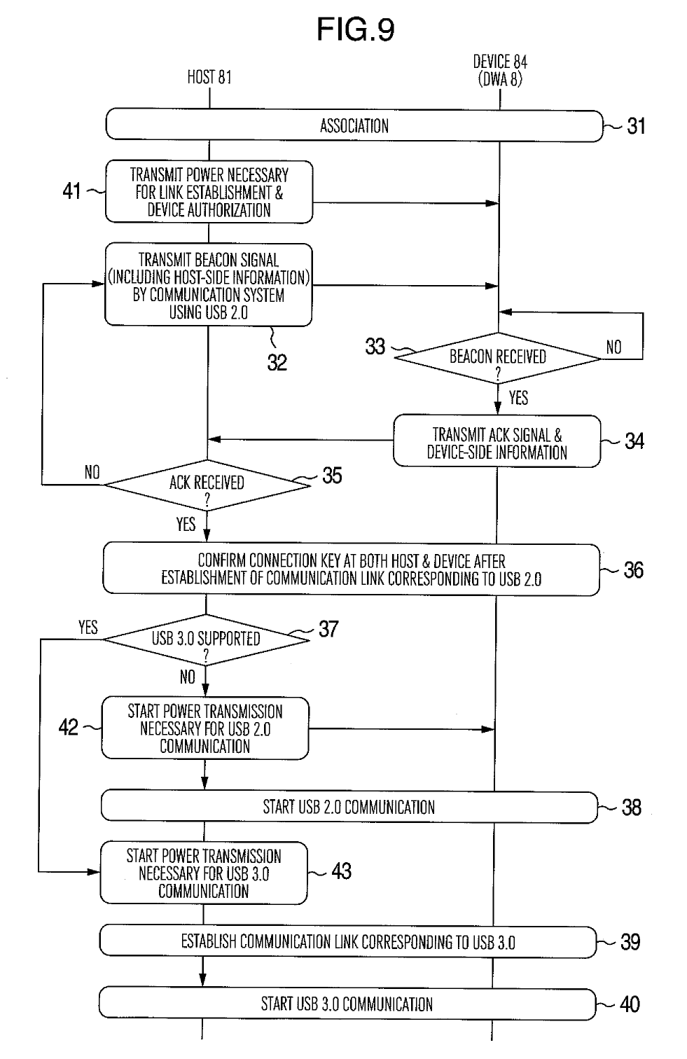

In the case of the wireless power transmission, steps 41 to 43 relating to power transmission are newly added to the operation sequence in FIG. 7, as shown in FIG. 9. The device 84 will be explained below in a similar way to the case in FIG. 7. The same goes for a case where the DWA 8 is used.

After executing the association at step 31, the host 81 starts wireless power transmission to the device 84 (or DWA 8) (step 41). At this time, a minimum amount of power is transmitted which is necessary for the link establishment and device authorization.

Thereafter, the host 81 uses the device-side information transmitted from the device 84 at step 34 to determine whether the device 84 supports USB 3.0 or not (step 37). Where the device 84 does not support USB 3.0, the host 81 starts power transmission necessary for the USB 2.0 communication (step 42). On the other hand, where the device 84 supports USB 3.0, the host 81 starts power transmission necessary for the USB 3.0 communication (step 43).

According to this example, it is possible to reduce power consumption by first transmitting the minimum power necessary for the link establishment and device authorization and thereafter controlling the transmitted power in accordance with the USB version of the connected device.

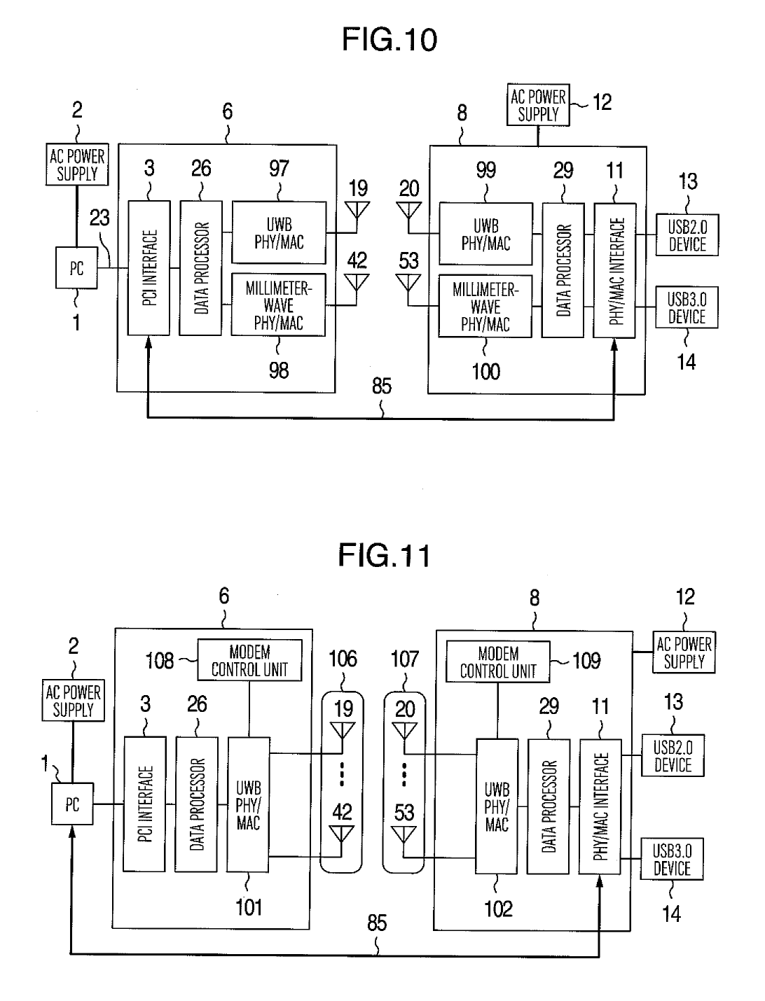

Although several cases where the PC 81 performs wireless communications with the DWA 8 or the device 84 have been explained above using FIGS. 1, 3, 4, 8, etc. this invention is not limited thereto. For example, by connecting a HWA (host wired adapter) to the PC, wireless communication may also be performed with the DWA 8 or else. Additionally, FIG. 10 shows a configuration example of a host where a PC 1 is connected to the HWA 6 in place of the PC 81 in FIG. 1. The same elements as those in FIG. 1, etc. are denoted by the same reference numerals, and explanations thereof are omitted herein.

Data to be transmitted from the PC 1 to the devices 13 and 14 is sent to the HWA 6 via a PCI (peripheral component interconnect) bus 23. At the HWA 6, data is sent to a data processing unit 26 via a PCI interface 3. The data processor 26 is provided with a

WUSB driver (software, not shown in the figure), a WUSB logic circuit (hardware, not shown in the figure), etc., to perform data processing of USB 2.0 and USB 3.0. More specifically, the data processor 26 is compliant with protocols of UWB system and high speed data transmission (millimeter-wave) system, and for example performs scheduling of data transmission/reception pursuant to UWB channel resources and millimeter-wave channel resources, and executes power management.

Where USB 2.0 data is transmitted, the data is modulated by the PHY/MAC 97 into a UWB signal and then transmitted from the antenna 19 to the antenna 20 of the DWA 8. On the other hand, where USB 3.0 data is transmitted, the data is modulated by the PHY/MAC 98 into a millimeter-wave signal and then transmitted from the antenna 42 to the antenna 53 of the DWA 8.

The UWB signal received by the antenna 20 is demodulated by the PHY/MAC 99, and the demodulated signal is sent to a data processor 29. The data processor 29 is provided with a WUSB driver (software, not shown in the figure), a WUSB logic circuit (hardware, not shown in the figure), etc., to perform data processing of USB 2.0 and USB 3.0. Data outputted by the data processor 29 is converted into USB 2.0 data by a PHY/MAC interface 11 and then transmitted to the device 13.

Similarly, the millimeter-wave signal received by the antenna 53 is converted to USB 3.0 data by the PHY/MAC interface 11 after demodulation by the PHY/MAC 100 and data processing by the data processor 29, and then transmitted to the device 14.

Meanwhile, where data is transmitted from the devices 13 and 14 to the PC 1, the data is processed step-by-step in the reverse order.

Note that although in this example the PC 1 and HWA 6 are connected via the PCI bus, this invention is not limited thereto. For example, the HWA 6 may also be configured in a PC built-in card form such as PCI Express™ card. The HWA 6 may also be connected using USB in place of the PCI bus.

In the system not only in FIG. 1 but also in FIG. 3, the PC 81 may also be replaced by the PC 1 and HWA 6. Although in the examples in FIGS. 1 and 3 the only PHY/MACs 99 and 100 are shown as the internal structure of the DWA 8, the DWA 8 has the data processor 29 and PHY/MAC interface 11 similar to that in FIG. 10. The PC 81 also has the data processor 26 in addition to the PHY/MACs 97 and 99.

The system in FIG. 4 may also uses the PC 1 and HWA 6 in place of the PC 81 as shown in FIG. 11.

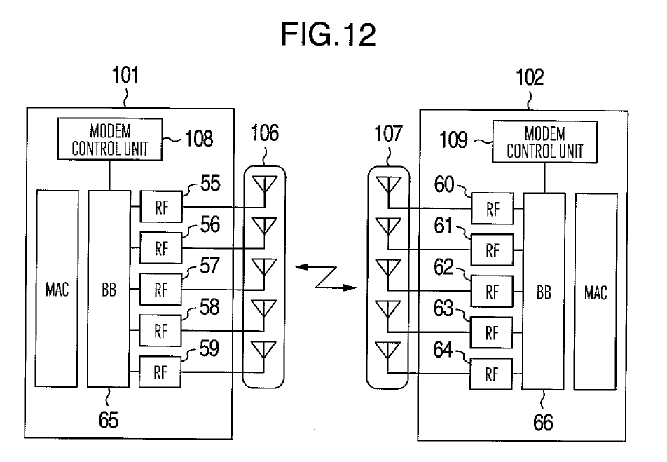

FIG. 12 shows one example of a detailed configuration of the PHY/MACs 101 and 102 in FIGS. 4 and 11. The PHY/MACs 101 and 102 are provided with RF (radiofrequency) circuit blocks (RF signal processing circuits) 55-59, 60-64, BB (baseband) blocks (baseband modem) 65 and 66, and MAC (i.e., wireless resource control circuit, circuit to control the frame configuration of data to be sent to BB blocks). In order to transmit/receive a plurality of band groups which are different in frequency from one another, it is necessary to provide at least two or more RF blocks. BB blocks perform modem processing of those signals sent from the plurality of RF blocks, but the modem control units 108 and 109 selects one among those modem schemes. Therefore, it is unnecessary to prepare BB blocks for each modem scheme, and thus miniaturization is achievable.

Where wireless power transmission is performed as shown in FIG. 8, the PC 1 and HWA 6 may also be used in place of the PC 81. In this case, the HWA 6 has a power transmission control unit 45 and a power transmitting antenna or transmitting coil 46, wherein the power transmission control unit 45 is connected to the PCI interface 3.

The methods discussed above can provide a wireless transmission system capable of supporting a plurality of WUSB schemes, while preventing power consumption from increasing. Although wireless communication systems supporting USB 2.0 and USB 3.0 have been discussed using FIGS. 1 to 12, USB 2.0 and USB 3.0 are used as examples, and this invention may also be applied to wireless communication systems using other USB schemes. This invention may be applied not only the USB schemes but also to other large-capacity wireless transmission systems.

It should be further understood by those skilled in the art that although the foregoing description has been made on embodiments of the invention, the invention is not limited thereto and various changes and modifications may be made without departing from the spirit of the invention and the scope of the appended claims.

1. A wireless communication system for performing data communication between a host and a device, wherein
the host is provided with a communication unit capable of data communication using a first communication system and a second communication system which is higher in maximum transmission rate than the first communication system, and
without regard to any communication system to be used by the device, the host uses the first communication system to start processing for establishment of a communication link with the device.

2. A wireless communication system for performing data communication between a host and a device, wherein
the host is provided with a communication unit capable of data communication using a first communication system and a second communication system which is higher in maximum transmission rate than the first communication system, and
the host uses the first communication system to start processing for establishment of a communication link with the device.

3. The wireless communication system according to claim 2, wherein
the processing for establishment of the communication link includes transmitting a beacon signal from the host to the device by the first communication system.

4. The wireless communication system according to claim 3, wherein
upon receiving the beacon signal, the device transmits to the host a device information containing information indicative of a communication system to be used by the device, and
based on the device information received, the host performs data communication with the device by the second communication system in place of the first communication system.
